(19) United States
(12) Patent Application Publication
(10) Pub. No.: US 2021/0265854 A1
(43) Pub. Date: Aug. 26, 2021

(54) Quik Charge™ Wireless Phone Charger

(71) Applicant: Jovon Ashton Clayton, Signal Hill, CA (US)

(72) Inventor: Jovon Ashton Clayton, Signal Hill, CA (US)

(21) Appl. No.: 17/157,954

(22) Filed: Jan. 25, 2021

Related U.S. Application Data
(60) Provisional application No. 62/995,964, filed on Feb. 24, 2020.

(51) Int. Cl. H02J 7/02; H02J 7/00

(52) U.S. Cl. CPC H02J 7/02; H02J 7/0042

(57) ABSTRACT

A wireless cell phone charger is meant to be an improvement in technology. It derives from the original cell phone chargers which has a cord, and a plug for wall outlets. The purpose of a wireless cell phone charger is, to re-charge a cell phone battery in a more convenient way which is cordless. It wirelessly re-charges the cell phone battery as well as sends and receives power simultaneously. Unlike the first cell phone chargers with cords and plugs, this device is portable.

### BACKGROUND

The purpose of a wireless cell phone charger is to take the place of chargers with cords and plugs for outlets. In the art, wireless cell phone chargers are generally known to be positioned on tabletops/countertops, desktops, or any flat surfaces. At this point, the cell phone is laid on top of the electronic wireless charging pad, where it begins to charge the cell phone efficiently. With the Quik Charge™ Wireless Phone Charger, it is capable of wirelessly charging cell phone devices efficiently yet compact enough to put in one's pocket or purse for charging on the go.

### SUMMARY

The Quick Charge™ Wireless Phone Charger is made for convenience to easily charge one's cell phone efficiently while on the go. Quik Charge™ charges the cell phone without using outlets. This wireless charger has the capability to fit into a pocket or purse. How it works is, you lay the phone on the charger for a wireless charge. You can do this in the comforts of your own home, or you can take it with you during your daily travels/commutes. When the Quik Charge™ needs to be regenerated, simply plug it in overnight. This device removes charging cords from being a necessity or waiting by an outlet until your cell phone charge is complete.

### BRIEF DESCRIPTION OF THE DRAWINGS

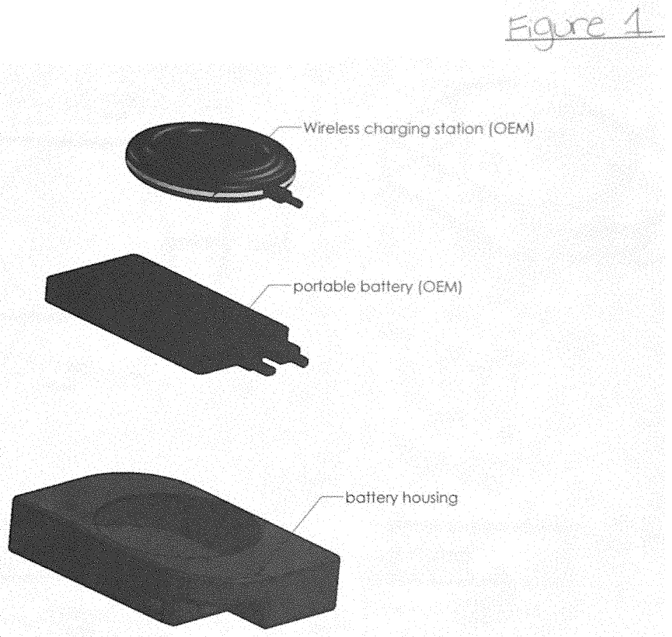

In FIG. 1, it shows the three main components that the drawing is made of which are:
1—The Wireless Charging Station (OEM) that is located on the top of the wireless charger. Its color is black with a circular shaped pad that is where the phone is placed on to charge.
2—A Portable Battery (OEM) which has a black rectangular shaped figure that is located underneath the Wireless Charging Station (OEM). This is where electronic power is transferred from into the Wireless Charging Station, and in turn radiates into the phone to recharge the bather.
3—The Battery Housing is an oval shaped object that houses the electronic battery power that is transmitted from the Portable Battery (OEM). The purpose of the Battery Housing is to circulate the electric currents in one place until it is ready to be transmitted back into the Portable Battery (OEM) and the Wireless Charging Station (OEM).

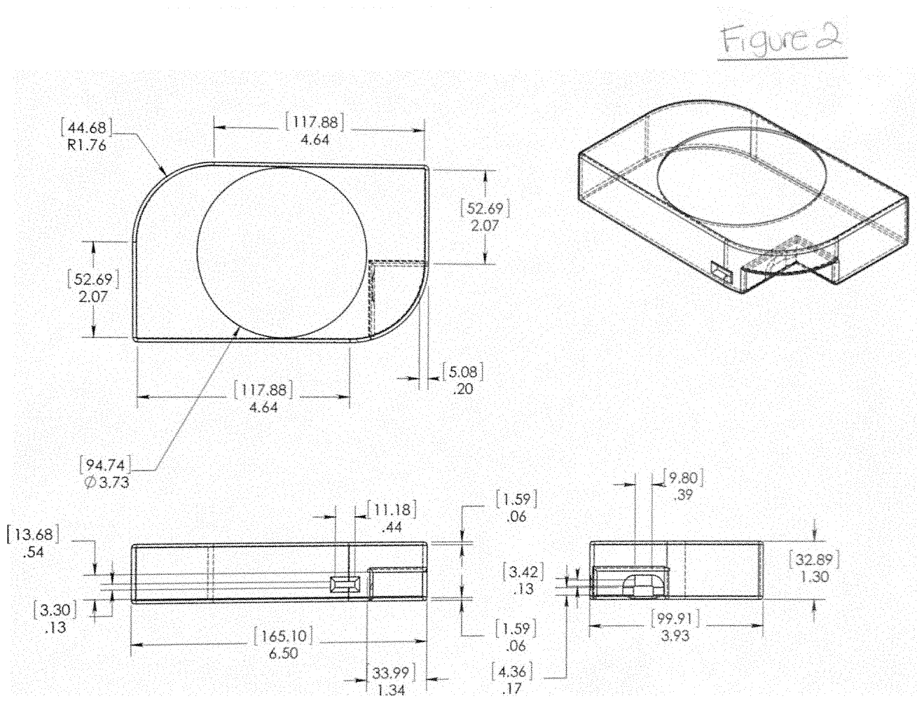

In FIG. 2, it gives measurements and sizes of the Battery Housing. It gives a list of information such as, what material it is made of, the thickness, color, quantity, scale, etc.

### DETAILED DESCRIPTION OF THE INVENTION

The purpose of the Quik Charge™ Wireless Cell Phone Charger, is to easily charge one's cell phone without the necessity of an electrical outlet. This compact product has the capability to fit in a pocket while charging wirelessly. This device is meant to be able to use anywhere especially while traveling. With this electronic device, cords and outlets are no longer needed, because it stops the cell phone from dying while in transition. This device is also very cost-effective as well as manufactured easily.

In addition to the products purpose, one might ask, how is it made? This product is comprised of an injection molded battery housing which is made of ABS. if you reference back to FIG. 1, it shows that the Quik Charge™ is made up of three main parts. The three main components are the Wireless Charging Station (OEM) which is located at the top of the wireless charger. It is a black colored circular shaped pad that has electricity flowing through it. This is where the cell phone is placed to receive its charge.

Secondly, the next main component is, a Portable Battery (OEM). This is located underneath the Wireless Charging Station (OEM). This device is black in color and has a rectangular shape. Electronic power is transferred from the Portable Battery (OEM), into the Wireless Charging Station (OEM), and in turn radiates electrical currents into the cell phone which quickly recharges the battery (hints the name Quik Charge™). The third main component is, the Battery Housing. This piece has an oval shape and is blue in color. The purpose of this part is to keep or “house” the electricity in the Battery Housing area until it is ready to be transmitted back into the Portable Battery (OEM) and the Wireless Charging Station (OEM).

Next, if you reference to FIG. 2, it conveys the measurements of the Battery Housing component. This is meant to give an idea of the size and measurements of the Wireless Charger. FIG. 2 lists the part name, project name, MFG. process, the material that it is made of, the thickness, color, quantity, sheet size, who it is drawn by, scale, units, etc. This visual helps one to imagine the size of the product if someone were to hold it in their hand.

Finally, how can one use the product? It is simple. By resting the cell phone on top of the Wireless Charging Station (OEM). This will quickly charge the cell phone efficiently. When the Quik Charge™ Wireless Phone Charger gets low on power itself from multiple uses, simply plug it in at night to be re-charged again for use the next day.

In conclusion, the Quik Charge™ Wireless Phone Charger is meant to be an improvement to wireless chargers that may already be on the market. Due to its compact size, this makes it easy to carry in a pocket or purse for convenience. This device is easily manufactured and has a cost-effective design.

The invention claimed is:

1- A portable wireless cell phone charger, comprising:
An injection molded battery housing comprised of ABS.
A Wireless Charging Station (OEM)
A Portable Battery (OEM)
A Battery Housing

2- An electronic charging system, comprising:
A said wireless cell phone charging efficient for radiating power back and forth simultaneously between the cell phone and the charger wirelessly.

3- A portable wireless cell phone charger, said charger:
An apparatus that is made small enough to fit in one's pocket.
